(19) United States
(12) Patent Application Publication
(10) Pub. No.: US 2025/0383582 A1
(43) Pub. Date: Dec. 18, 2025

(54) ACTUATOR FOR CAMERA

(71) Applicant: JAHWA electronics Co., Ltd., Chungcheongbuk-do (KR)

(72) Inventors: IN CHEOL HONG, Chungcheongbuk-do (KR); CHUL SOON PARK, Chungcheongbuk-do (KR); JAE YONG GO, Chungcheongbuk-do (KR)

(21) Appl. No.: 19/098,072

(22) Filed: Apr. 2, 2025

(30) Foreign Application Priority Data
Jun. 17, 2024 (KR) 10-2024-0078015

(51) Int. Cl. G03B 5/00; G02B 27/64; H01F 7/08

(52) U.S. Cl. CPC G03B 5/00; G02B 27/646; H01F 7/081; G03B 2205/0023; G03B 2205/0069

(57) ABSTRACT

An actuator for a camera according to an embodiment includes a plurality of moving bodies rotating in different directions, a magnet installed on each of the plurality of moving bodies, and a back yoke provided at a rear side of at least one of the magnets respectively installed on the plurality of moving bodies. The back yoke includes a cover that forms a gap with a side surface of a magnet provided at a front side thereof and covers the side surface.

### CROSS-REFERENCE TO RELATED APPLICATION AND CLAIM OF PRIORITY

This application claims the benefit under 35 USC § 119 of Korean Patent Application No. 10-2024-0078015 filed on Jun. 17, 2024, in the Korean Intellectual Property Office, the entire disclosure of which is incorporated herein by reference for all purposes.

### BACKGROUND

### 1. Technical Field

The present disclosure relates to an actuator for a camera, and more specifically, to an actuator for a camera with improved driving precision through structural improvement of a back yoke.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

Meanwhile, mobile terminals are recently equipped with zoom lenses with specifications such as the ability to variably adjust the focal length or capture images from a distance in order to meet ever-increasing user needs and implement more diverse user convenience.

The zoom lenses have a structure in which a plurality of lenses or lens groups are arranged side by side or the lens itself has a long length in the optical axis direction, so a larger mounting space must be provided in the mobile terminal.

Recently, in order to organically combine the physical characteristics of the zoom lens with the geometrical characteristics of the mobile terminal, an actuator or camera module with a physical structure that refracts the light of the subject using a reflector placed at the front of the lens has been disclosed.

The actuator or the like that employs a reflector implements OIS by moving (rotating) the reflector, which reflects the light of the subject toward the lens, along one or two axes, rather than compensating for the movement of the lens, when shaking occurs.

Typically, such an actuator or device is provided with a plurality of moving bodies for independent rotational operation in each direction, and each of these moving bodies is equipped with a magnet for driving in an individual direction.

Since each of the plurality of moving bodies must rotate relatively, if a magnet installed in a moving body is affected by the magnetic field of a magnet installed in another moving body or interference occurs between the magnetic fields of the magnets, the position or posture of the carrier, which is a moving body, may dynamically and randomly change in time, which may cause defects.

Therefore, such magnetic interference, etc. may cause errors in the position detection of each moving body, and also destroy the linear relationship between position detection and the resulting position control, which may deteriorate the driving performance of the actuator itself, which is continuously subject to feedback control.

If a module for implementing AF or zoom functions is added to an actuator for a camera according to an embodiment, more magnets are included to implement AF, etc., so problems such as mutual interference due to magnetic fields may become more severe.

### SUMMARY

The present disclosure is designed to solve the problems of the related art, and therefore the present disclosure is directed to providing an actuator for a camera, which may enhance a driving force by improving the structural relationship between a magnet and a back yoke and also minimize magnetic interference between adjacent magnets.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

An actuator for a camera according to an embodiment of the present disclosure may include a plurality of moving bodies rotating in different directions; a magnet installed on each of the plurality of moving bodies; and a back yoke provided at a rear side of at least one of the magnets respectively installed on the plurality of moving bodies.

In this case, the back yoke may include a cover that forms a gap with a side surface of a magnet provided at a front side thereof and covers the side surface.

Specifically, the cover of the present disclosure may be provided at a side where magnets installed on different moving bodies approach each other by a rotation of the moving body.

An actuator for a camera according to an embodiment of the present disclosure may include a carrier having a reflector installed thereon and rotating in a first direction; a middle guide rotating in a second direction perpendicular to the first direction; a first magnet installed on the carrier; a second magnet installed on the middle guide; and a back yoke provided at a rear side of at least one of the first and second magnets.

In this case, the back yoke may include a cover that forms a gap with a side surface of a magnet provided at a front side thereof and covers the side surface.

Preferably, the actuator for a camera according to an embodiment of the present disclosure may further include a housing configured to support the second direction rotation of the middle guide, and the middle guide may support the first direction rotation of the carrier and rotate together with the carrier during the second direction rotation.

In addition, the back yoke of the present disclosure may include a first back yoke provided between the carrier and the first magnet; and a second back yoke provided between the middle guide and the second magnet, and in this case, at least one of the first or second back yokes may include the cover.

The cover of the present disclosure may be provided at a side where the first and second magnets approach each other by the first direction rotation.

An actuator for a camera according to an embodiment of the present disclosure may include a carrier rotating in a first direction and having a reflector and a first magnet installed thereon; a middle guide rotating in a second direction perpendicular to the first direction and having a second magnet installed thereon; a third carrier moving in an optical axis direction and having a third magnet installed thereon; and a third back yoke provided between the third carrier and the third magnet.

In this case, the third back yoke may include a third cover that covers a side surface of the third magnet and forms a gap with the side surface of the third magnet.

Here, the third cover of the present disclosure may be provided at a side where the third magnet approaches the first or second magnet by a movement in the optical axis direction of the third carrier.

An actuator for a camera according to an embodiment of the present disclosure may include a carrier rotating in a first direction and having a reflector and a first magnet installed thereon; a middle guide rotating in a second direction perpendicular to the first direction and having a second magnet installed thereon; a third carrier moving in an optical axis direction and having a third magnet installed thereon; and a back yoke provided at a rear side of at least one of the first and second magnets.

In this case, the back yoke may include a cover that forms a gap with a side surface of a magnet provided at a front side thereof and covers the side surface, and the cover may be provided at a side where the third magnet approaches the first or second magnet by a movement in the optical axis direction of the third carrier.

According to a preferred embodiment of the present disclosure, the leaked magnetic field may be reduced through structural improvement of the back yoke that induces magnetic field concentration of the magnet, and further enhanced driving force may be provided in the relationship between the magnet and the coil facing the magnet.

According to the present disclosure, since the driving force may be increased based on a magnet of the same specification, the entire structure and shape of the actuator may be implemented in a more space-intensive form, which may not only minimize the overall space, but also be further optimized for miniaturization of mobile terminals.

According to one embodiment of the present disclosure, magnetic field interference between moving bodies rotating three-dimensionally in a three-dimensional space may be minimized, thereby more effectively securing driving independence and operational reliability in each direction for a moving body that operates finely and precisely.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a camera and a camera module according to a preferred embodiment of the present disclosure,

FIGS. 3 and 4 are exploded views showing the detailed configuration of the actuator for a camera according to a preferred embodiment of the present disclosure,

FIG. 5 is a diagram for illustrating the operational relationship in which the reflector rotates in a first direction,

FIG. 6 is a diagram for illustrating the operational relationship in which the reflector rotates in a second direction,

FIGS. 7 and 8 are exploded views showing the detailed configuration of a carrier or a middle guide on which a back yoke is installed,

FIG. 9 is a drawing showing the structural relationship between a first back yoke and a first magnet,

FIG. 10 is a drawing showing the structural relationship between a second back yoke and a second magnet,

FIGS. 11 and 12 are drawings showing a third carrier moving in the optical axis direction, and

FIGS. 13 and 14 are drawings showing the structure of a third back yoke installed on a third carrier and its relationship with adjacent configurations.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

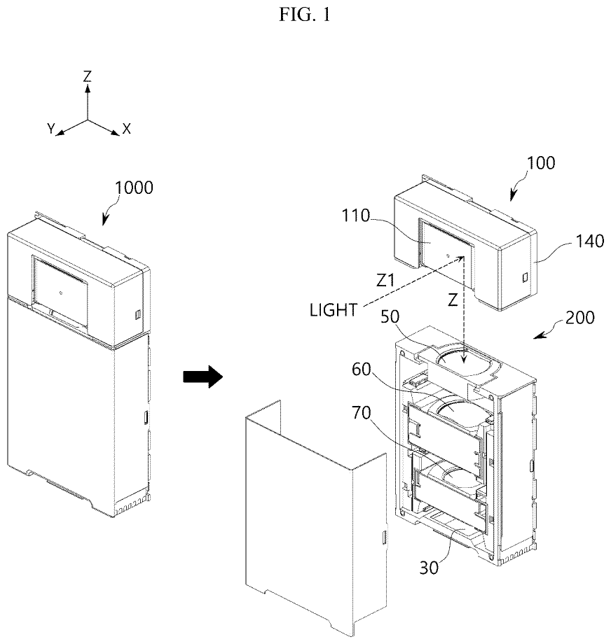

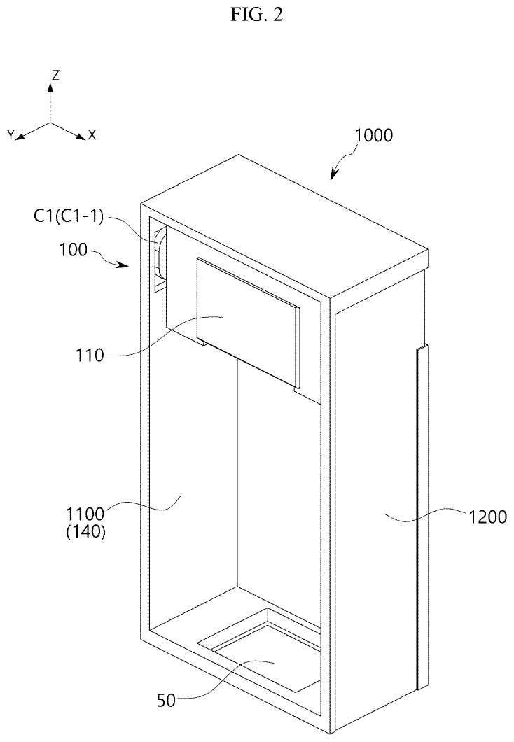

FIGS. 1 and 2 are diagrams showing the overall configuration of an actuator 100 for a camera (hereinafter, referred to as an ‘actuator’) and a camera module 1000 according to a preferred embodiment of the present disclosure.

The actuator 100 of the present disclosure may be implemented as a single device, and as shown in FIG. 1, may be implemented in the form of a camera module 1000 including at least one lens 50, 60, 70, a lens driving module 200 for implementing zoom and/or autofocus (AF), or the like, and an image sensor 30. Also, according to an embodiment, the actuator 100 of the present disclosure may be implemented in a form including a lens driving module 200.

In the actuator 100 of the present disclosure, the light of a subject does not flow directly into the lens 50, 60, 70, but the actuator 100 is configured such that the light of a subject flows into the lens 50, 60, 70 after changing (refracting, reflecting, or the like) the path of light through a reflector 110 provided in the actuator 100 of the present disclosure.

As illustrated in FIG. 1, the path of light coming from the outside is Z1, and the path of light coming from the outside and flowing into the lens 50, 60, 70 after being refracted or reflected by the reflector 110 is Z.

In the following description, Z-axis direction corresponding to the direction in which light flows into the lens 50, 60, 70 is referred to as an optical axis or an optical axis direction, and two directions perpendicular to the Z-axis direction are referred to as X-axis and Y-axis.

Based on the optical axis direction, an image sensor 30 such as CCD or CMOS that converts light signals into electrical signals may be provided at the rear end of the lens 50, 60, 70, and a filter that blocks or transmits light signals in a specific band may be provided together. Of course, the number and location of lenses 50, 60, 70 may be different from those shown in the drawings depending on the embodiment.

As will be described in detail later, the actuator 100 of the present disclosure corresponds to a device that implements OIS for the X-axis direction or/and Y-axis direction by rotating the reflector 110 in a direction that compensates for the movement when shaking due to hand tremor occurs based on the X-axis direction and/or Y-axis direction perpendicular to the optical axis.

As illustrated in FIG. 1, the actuator 100 of the present disclosure may be implemented as an independent device and combined with other devices constituting the camera module 1000, and may also be implemented in various forms, such as being included inside a housing 1100 of the camera module 1000 as illustrated in FIG. 2 or the like.

In this case, a housing 140, which is a component of the actuator 100, may be the housing of the actuator 100 itself or the housing 1100 of the camera module 1000.

The axes shown in the drawings, terms referring to the axes, and terms such as “upper”, “lower”, “front”, “rear”, “vertical”, “horizontal”, or the like described with respect to the axes are intended to present a relative standard for describing an embodiment of the present disclosure, and it is obvious that these terms are not intended to specify any direction or location on an absolute basis. Of course, these terms may vary relatively depending on the location of a target object or observer, the view direction, or the like.

In the following description, an embodiment of the present disclosure will be described with the Z-axis as a standard for the upper and lower direction or the vertical direction, and from a corresponding perspective, an embodiment of the present disclosure will be described with the Y-axis as a standard for the front or rear direction and the X-axis as a standard for the left or right direction.

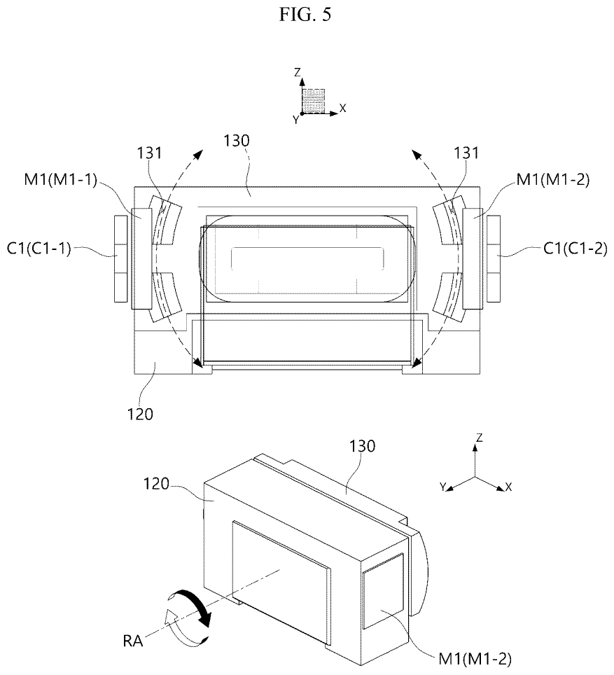

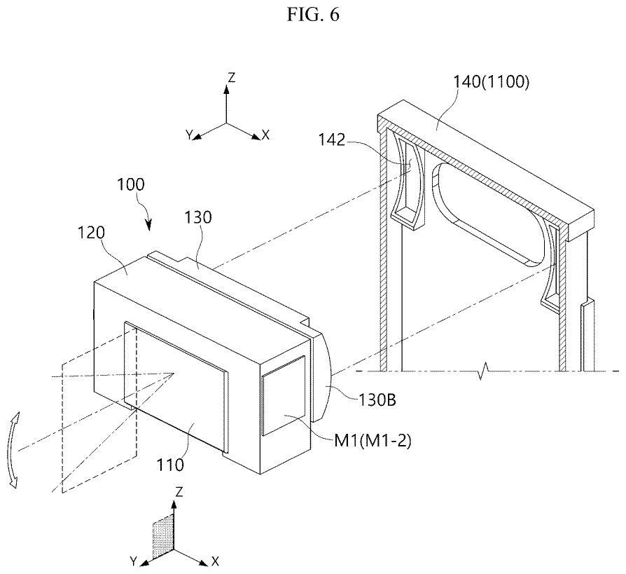

Based on the actuator 100 according to an embodiment of the present disclosure, as will be explained later, the XZ plane or a corresponding plane becomes a plane direction (see FIG. 5) in which the carrier 120 rotates with the middle guide 130 as a relative stator, and the YZ plane becomes a plane direction (see FIG. 6) in which the middle guide 130 of the present disclosure rotates with respect to the housing 140, 1100 together with the carrier 120.

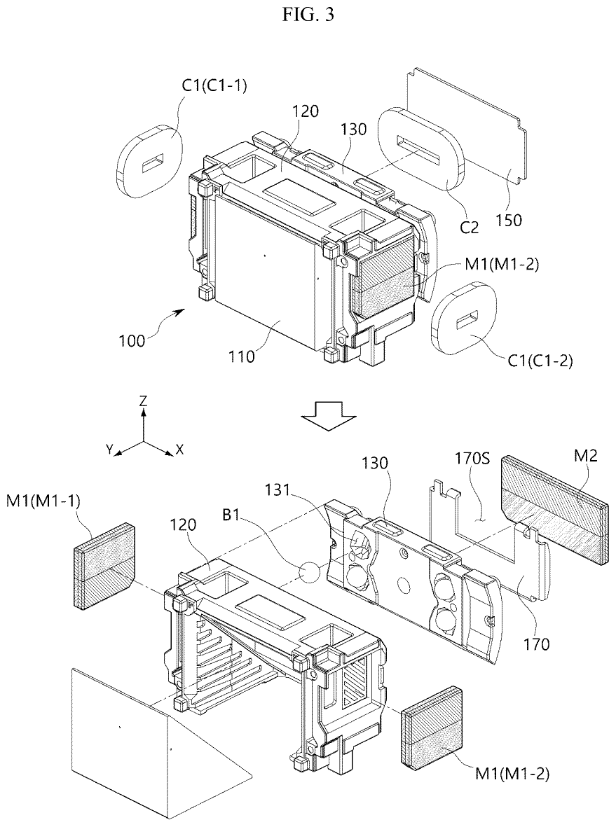

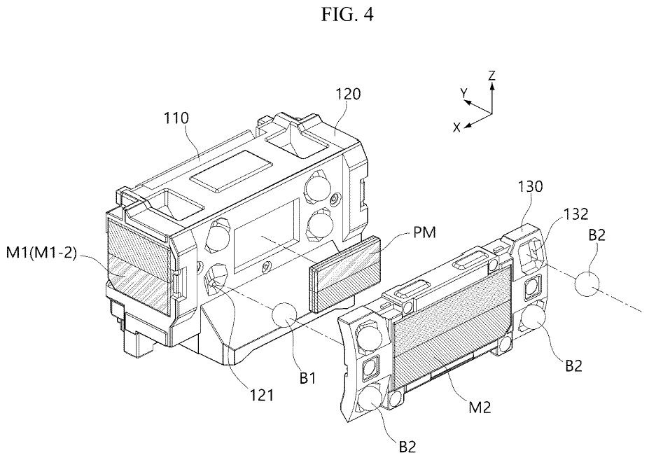

FIGS. 3 and 4 are exploded views showing the detailed configuration of the actuator 100 according to a preferred embodiment of the present disclosure.

As shown in FIG. 3 or the like, the actuator 100 according to an embodiment of the present disclosure may be configured to include a reflector 110, a carrier 120, a middle guide 130, and a housing 140. As described above, the housing 140 of the actuator 100 may be the housing 1100 of the camera module 1000 or a housing of a device integrated with the lens driving module 200.

First, the overall configuration of the actuator 100 will be described with reference to the drawings, and the detailed configuration and driving relationship of the actuator 100 for OIS operation in each direction will be described later.

As described above, when the light of an object, which is incident with a Z1 path, flows into the actuator 100 of the present disclosure, the reflector 110 of the present disclosure changes (refracting, reflecting, or the like) the path of light to the optical axis direction Z and introduces the light into the lens 50, 60, 70.

The reflector 110 may be one of a mirror or a prism, or a combination thereof, and may further be implemented as a variety of members that can change the path of light introduced from the outside to the optical axis direction.

Since the actuator 100 of the present disclosure is configured so that the path of light is refracted by the reflector 110 and then flows into the lens 50, 60, 70, it is not necessary to install the lens driving module 200 itself in the thickness direction of a mobile terminal (smartphone or the like). Therefore, even if an optical member having a long physical characteristic in the optical axis direction, such as a zoom lens, is mounted to a portable terminal, the thickness of the portable terminal does not increase, which may be optimized for miniaturization of the portable terminal.

As well known in the art, OIS operation is implemented by moving the lens or the like in a direction that compensates for shaking caused by hand tremor. However, in the embodiment to which the present disclosure is applied, unlike the method of reverse-moving the lens or the like, OIS operation is implemented by moving the reflector 110.

The reflector 110 of the present disclosure is installed at the actuator 100 in a direction in which light enters, namely in a direction toward the front surface in the Y-axis direction, and is fixed to the carrier 120 to physically move together with the carrier 120.

If the carrier 120 of the present disclosure makes rotational movement (based on the XZ plane) based on the middle guide 130 (as a relative stator) or the middle guide 130 of the present disclosure makes rotational movement (based on the YZ plane) based on the housing 140 (as a relative stator) together with the carrier 120, the reflector 110 installed at the carrier 120 also rotates in the same direction.

Preferably, a first ball B1 may be placed between the carrier 120 and the middle guide 130, and a second ball B2 may be placed between the middle guide 130 and the housing 140.

When the balls B1, B2 are interposed, the moving element may linearly move more stably due to minimized friction by the balls' rolling, moving, rotation, and point-contact to the facing object, and has the advantage of reducing noise, minimizing the driving force, and improving the driving precision.

As will be explained later, when the carrier 120 at which the reflector 110 is installed makes rotational movement based on the XZ plane with the middle guide 130 as a relative stator (see FIG. 5), the path of light flowing into the image sensor 30 moves to the X-axis direction due to the rotational movement of the reflector 110, and correct the hand tremor in the X-axis direction.

In addition, when the carrier 120 at which the reflector 110 is installed rotates based on the YZ plane together with the middle guide 130 (see FIG. 6), the path of light flowing into the image sensor 30 moves to the Y-axis direction due to the rotational movement of the reflector 110, and correct the hand tremor in the Y-axis direction.

In the following description, the direction in which the reflector 110 makes rotational movement on the plane corresponding to the XZ plane in relation to the image stabilization in the X-axis direction is referred to as a ‘first direction’, and the direction in which the reflector 110 makes rotational movement on the plane corresponding to the YZ plane in relation to the image stabilization in the Y-axis direction is referred to as a ‘second direction’.

In this respect, the middle guide 130 of the present disclosure corresponds to a stator in a relative relationship with the carrier 120 for the first direction rotational movement, but corresponds to a moving element in a relative relationship with the housing 140 for the second direction rotational movement.

As shown in FIGS. 3 and 4, a second magnet M2 for driving OIS in the second direction may be installed on the middle guide 130.

According to an embodiment, the second magnet M2 may be installed on the middle guide 130 in a state where a back yoke 170 is interposed therebetween to prevent leakage of magnetic force and to concentrate the magnetic force so as to strengthen the magnetic force between the second coil C2 and the second magnet M2.

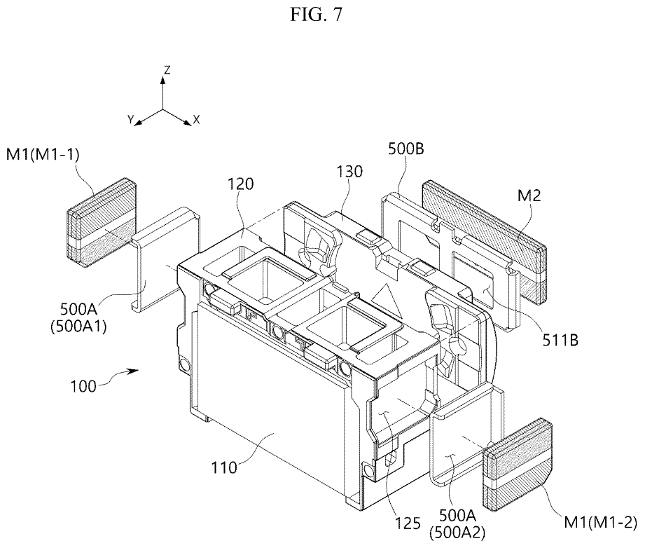

The back yoke 170 installed at the rear of the second magnet M2 and the back yoke 500 provided on the magnet installed on the first magnet M1 or the moving body (carrier) moving in the optical axis direction (Z-axis direction) will be described later in detail with reference to FIGS. 7 to 14.

The pulling magnet PM of the present disclosure is configured to be installed on the carrier 120, and is installed in a direction to face the second magnet M2 as illustrated in the drawings. Based on FIG. 4, the pulling magnet PM is installed on the rear surface (based on the Y-axis) of the carrier 120, and based on the middle guide 130, the magnetic body PM is disposed at the front (based on the Y-axis) of the middle guide 130.

The pulling magnet PM includes a magnetic pole (hereinafter, referred to as a ‘counter magnetic pole’) that faces the facing magnetic pole and has the opposite polarity to the facing magnetic pole, which is a magnetic pole of the second magnet M2 that faces the pulling magnet PM. The counter magnetic pole is positioned at a position corresponding to the facing magnetic pole with respect to the default position (reference position) of the carrier 120.

The pulling magnet PM generates an attractive force on the second magnet M2, so that the carrier 120 equipped with the pulling magnet PM comes into close contact with the middle guide 130.

Since the second magnet M2 is installed on the middle guide 130 and the pulling magnet PM is installed on the carrier 120, if an attractive force is generated between the pulling magnet PM and the second magnet M2, the carrier 120 is pulled toward the middle guide 130, so the carrier 120 and the middle guide 130 between which the first ball B1 is interposed are brought into close contact.

By means of this attractive force, point contact may be continuously maintained between the first ball B1 and the carrier 120, as well as between the first ball B1 and the middle guide 130.

In addition, even if the carrier 120 rotates based on the XZ plane due to the driving of the first direction OIS, if the OIS driving, etc. is terminated or stopped, the pulling magnet PM restores the position or posture of the carrier 120 to a position or posture in which the facing magnetic pole of the second magnet M2 and the counter magnetic pole of the pulling magnet PM are aligned or correctly arranged to face each other.

Hereinafter, the detailed configuration and driving relationship of the actuator 100 for OIS driving in each direction will be described with reference to FIGS. 5, 6, and the like.

As shown in the drawings, a first magnet M1 for OIS operation in the first direction is installed at the carrier 120 where the reflector 110 is installed. The first magnet M1 may be installed at the left and right sides of the carrier 120, respectively, as illustrated in the drawings (M1-1, M1-2) in order to improve the driving efficiency.

A first coil C1 facing the first magnet M1 is installed in the housing 140. When a plurality of first magnets M1 are installed, the first coil C1 may also be installed in plurality (C1-1, C1-2).

When power of an appropriate magnitude and direction is applied to the first coil C1 through the control of an operation driver (not shown) to generate a magnetic force (electromagnetic force) between the first coil C1 and the first magnet M1, the carrier 120 rotates through the guiding of the first ball B1 in a state of facing the middle guide 130 (plane to plane) (see FIG. 5), and the X-axis direction OIS, i.e., the first direction OIS, is implemented by this rotational movement. In this case, the rotary axis RA for the first direction OIS corresponds to the Y-axis.

As shown in the drawings, a first ball B1 is placed between the carrier 120 and the middle guide 130. The first ball B1 may be placed such that a portion of the first ball B1 is accommodated between the first rail 131, which is provided on a surface of the middle guide 130 that faces the carrier 120 among surfaces of the middle guide 130 and has a rounded shape (e.g., a track shape), and the first guider 121 provided on the carrier 120.

One of the first rail 131 and the first guider 121 may be implemented as a rail shape with a continuous or partially continuous groove, and may also be implemented as a pocket shape that prevents external escape of the first ball B1.

Depending on the embodiment, a detection sensor may be further included in the configuration for operation control of OIS. In this case, when the detection sensor detects the position of the carrier 120 (specifically, the first magnet M1 or the sensing magnet installed at the carrier 120, or the like) and transmits the corresponding signal to the operation driver, the operation driver controls power of the corresponding magnitude and direction to be applied to the first coil C1.

The detection sensor may be implemented as a Hall sensor that detects the change in magnitude and direction of the magnetic field of a magnet present within the detection area using the Hall effect and outputs an electrical signal accordingly.

From a corresponding point of view, when power of appropriate magnitude and direction is applied to the second coil C2 through control of the operation driver (not shown), a magnetic force (electromagnetic force) is generated between the second coil C2 and the second magnet M2, and the middle guide 130 makes rotational movement in the second direction based on the housing 140 (as a relative stator) together with the carrier 120 using the generated magnetic force as a driving force (see FIG. 6).

In addition, as shown in the drawings, a second rail 132 having a rounded shape is provided on the rear surface 130B (based on the Y-axis) of the middle guide 130, and a second guider 142 is provided on the housing 140 facing the rear surface of the middle guide 130.

In this case, the second ball B2 may be placed between the second rail 132 and the second guider 142. Of course, the second rail or/and the second guider 142 may be formed such that a groove portion is extended to accommodate a portion of the second ball B2 as illustrated in the drawings, or may be formed to have a pocket shape to prevent the second ball B2 from being separated externally.

The yoke plate 150 is provided on the housing 140, which functions as a relative stator for the second direction movement of the middle guide 130, and generates an attractive force with the second magnet M2 installed on the middle guide 130.

By the attractive force between the yoke plate 150 and the second magnet M2, point contact between the middle guide 130 and the second ball and between the second ball B2 and the housing 140 may be continuously maintained.

Since the middle guide 130 is in close contact with the housing 140 by the attractive force of the yoke plate 150 and the second rail 132 with the second ball B2 interposed therein and the second guider 142 face each other as described above, when a magnetic force is generated between the second coil C2 and the second magnet M2, the middle guide 130 rotates (second direction rotation) along the rounded shape of the second rail 132 with the second ball B2 interposed therein and/or the second guider 142.

If the first direction rotation is driven, the middle guide 130 of the present disclosure functions as a stator in a relative relationship with the carrier 120 and supports the first direction rotational movement of the carrier 120.

If the second direction rotational movement is driven, the housing 140 of the present disclosure functions as a stator in a relative relationship with the middle guide 130 and supports the second direction rotational movement of the middle guide 130.

The first rail 131 formed on the middle guide 130 may have a rounded shape like a track based on the XZ plane, as illustrated in the drawings, to guide the first direction rotational movement of the carrier 120. The second rail 132 may be formed in a rounded shape based on the YZ plane to guide the second direction rotational movement of the middle guide 130 along with the carrier 120.

The first rail 131 and the second rail 132 are formed in directions perpendicular to each other, and the second ball B2 is placed to be accommodated between the second rail 132 and the second guider 142. Thus, when the carrier 120 rotates in the first direction with the middle guide 130 as a relative stator through the guiding of the first rail 131 or the like, the second rail 132, the second ball B2, the second guider 142, and the like function as physical structures that suppress the rotational movement of the middle guide 130.

Due to this structural relationship, even if a magnetic force (electromagnetic force) is generated between the first magnet M1 and the first coil C1, the middle guide 130 may maintain a fixed position in relation to the housing 140.

From a corresponding point of view, when a driving force is generated at the second magnet M2 due to the magnetic force between the second magnet M2 and the second coil C2, the middle guide 130 makes rotational movement in the second direction (YZ plane) through the guidance of the second rail 132, the second guider 142, the second ball B2 interposed therebetween, or the like.

In this case, since the carrier 120 maintains a fixed position in relation to the middle guide 130 due to the restraining structure by the first rail 131, the first ball B1 and the first guider 121, the carrier 120 makes rotational movement in the second direction together with the middle guide 130.

The first coil C1, the second coil C2, the Hall sensor, the operation driver, and the like may be mounted to a circuit board 1200 installed at the camera module 1000 or a circuit board provided in the actuator 100 itself. The circuit board 1200 is preferably configured so that a part thereof is exposed to the outside for interfacing with external modules, power supplies, external devices, or the like.

The first guider 121 and the first rail 131, together with the first balls B1, perform the function of guiding while physically supporting the movement of the carrier 120, which rotates with the middle guide 130 as a relative stator.

Therefore, if the pulling magnet PM is positioned at the center of the rear surface of the carrier 120 and the first guider 121 is provided at the outer side of the pulling magnet PM, the tilt or gap of the carrier 120 is minimized, and also the first direction rotation of the carrier 120 may be made more stably.

If a reflector that reflects light from a subject toward the lens may be moved or rotated in the X-axis and Y-axis directions, i.e., in different directions, a moving body having a different physical structure from the embodiment of the present disclosure described with reference to FIGS. 1 to 6 may be applied.

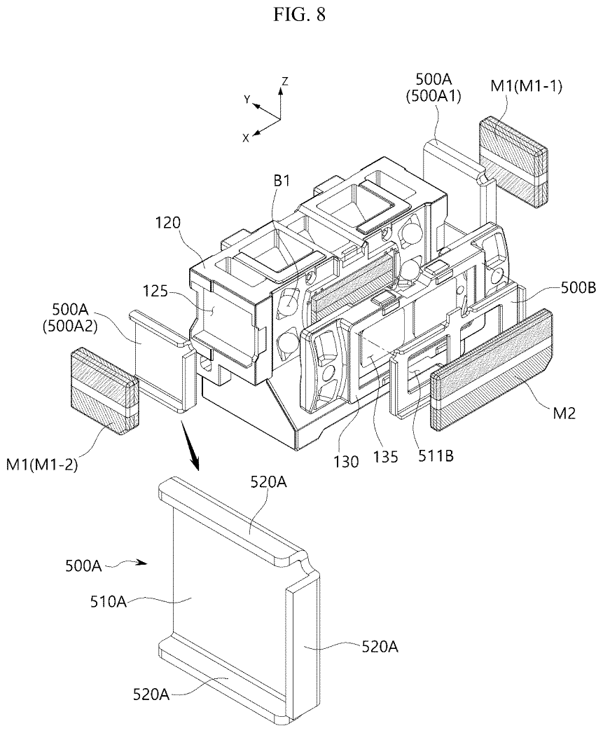

FIGS. 7 and 8 are exploded views showing the detailed configuration of the carrier 120 on which the back yoke 500, specifically the first back yoke 500A, is installed and the middle guide 130 on which the second back yoke 500B is installed.

The back yoke may be installed on the rear surface of the magnet, that is, on a surface of the magnet opposite to the surface facing faces the coil. The back yoke performs the function of reducing the magnetic force leakage between the coil and the magnet and increasing the magnetic force between the coil and the magnet.

As shown in FIG. 7, the first back yoke 500A is installed at the rear side of the first magnet M1 (a side of the first magnet opposite to the surface facing the first coil C1) to prevent magnetic force leakage and increase magnetic force.

As described above, when the first magnet M1 is installed at both sides of the carrier 120 to increase driving force, etc., the first back yoke 500A may also be provided at the rear of each first magnet M1 (500A1, 500A2).

As illustrated in the drawings, a first mounter 125, which is a space for mounting the first magnet M1, is formed in the carrier 120, and the first magnet M1 may be installed in the first mounter 125 with the first back yoke 500A interposed therebetween.

From a corresponding perspective, a second mounter 135, which is a space for mounting the second magnet M2, may be formed in the middle guide 130, and the second magnet M2 may be installed in the middle guide 130 with the second back yoke 500B interposed therebetween.

In order to increase the position fixing force of the magnets M1, M2 and to increase the efficiency of assembly processes such as alignment, it is preferable that the mounters 125, 135 are configured so that their side surfaces are put into the interior of the carrier 120 or the middle guide 130, as shown in the drawings, so as to form a kind of guiding wall.

The back yokes 500A, 500B are made of a magnetic material for preventing magnetic leakage and concentrating magnetic force, and may be configured to be partially or fully embedded in the mounters 125, 135 through insert injection/molding, etc., depending on the embodiment.

Specifically, the first back yoke 500A is provided at the rear side of the first magnet M1 (in the negative X-axis direction based on FIG. 8) and includes a body plate 510A functioning as a body of the back yoke 500A and a cover 520A. For relative distinction, the cover of the first back yoke 500A is referred to as a first cover 520A, and the cover of the second back yoke 500B is referred to as a second cover 520B.

The first cover 520A of the first back yoke 500A is configured to protrude from the body plate 510A toward the first coil C1 by means of bending, bonding, pressing, etc., and to cover the side surface of the first magnet M1. The second back yoke 500B provided at the rear side of the second magnet M2 may also include a body plate 510B and a second cover 520B, like the first back yoke 500A.

Because the back yoke 500B is located between the pulling magnet PM and the second magnet M2 and is made of a magnetic material, it is possible to reduce the suction force and return force (return force to return to the reference position) between the pulling magnet PM and the second magnet M2.

In order to effectively resolve these issues, it is preferable that an open portion 511B is formed in an area or section corresponding to the area where the second magnet M2 of the second back yoke 500B faces the pulling magnet PM, as illustrated in FIGS. 7 and 8. The back yoke 170 and the open portion 170S illustrated in FIG. 3 are also the same.

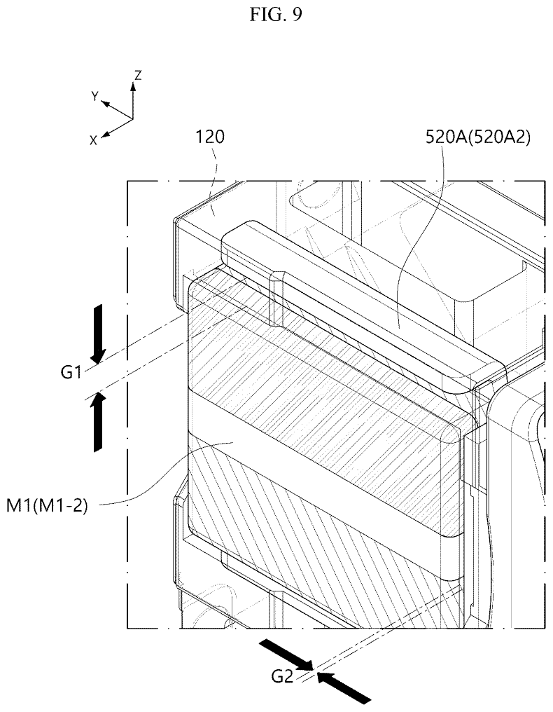

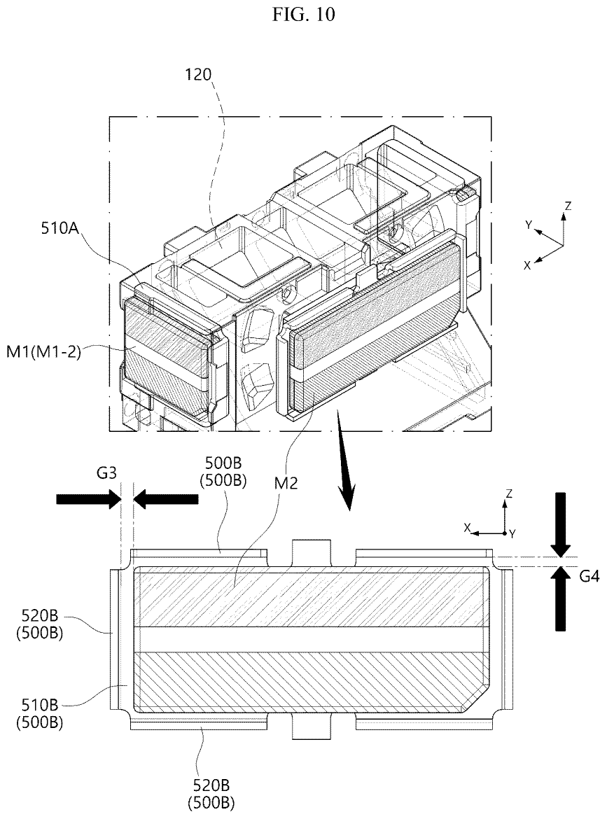

FIG. 9 is a drawing for illustrating the structural relationship between the first back yoke 500A and the first magnet M1, and FIG. 10 is a drawing for illustrating the structural relationship between the second back yoke 500B and the second magnet M2. Hereinafter, the specific configurations of the back yokes 500A, 500B of the present disclosure will be explained in detail with reference to the drawings.

The first cover 520A of the first back yoke 500A is configured to surround the side surface of the first magnet M1, but as shown in the drawings, it is preferable that the first cover 520A is spaced apart from the side surface of the first magnet M1 by a predetermined distance so that gaps G1, G2 are formed with the side surface of the first magnet M1.

The magnetic field of a magnet has a curved shape and is formed in a three-dimensional space. When a magnetic body exists at an appropriate location adjacent to the magnetic field, the line of magnetic force extends or expands to a position where the magnetic body is located.

As illustrated in the drawings, when the first cover 520A of the first back yoke 500A is installed to surround the side surface of the first magnet M1 but to be spaced apart from the side surface of the first magnet M1, the magnetic field formed in the first magnet M1 is extended toward the first cover 520A, which is an adjacent magnetic body, and this magnetic field extension phenomenon is induced throughout the three-dimensional space, so that the electromagnetic force (magnetic force) may be enhanced in the relationship with the first coil C1 facing the first magnet M1.

From a corresponding viewpoint, it is also desirable that the second cover 520B of the second back yoke 500B is configured to surround the side surface of the second magnet M2 while forming a gap G3, G4 with the side surface of the second magnet M2.

If the directionality and intensity of the magnetic field generated by the first magnet M1 are improved as above, the magnetic field may be suppressed from leaking outward or being formed in a direction other than the direction toward the coil, thereby reducing magnetic field interference in the relationship with adjacent magnets.

In this respect, even if a smaller magnet is used compared to a magnet of the same specifications, the magnet may have the same or greater magnetic force (electromagnetic force), thereby increasing the driving efficiency in relation to the coil.

Since the magnet is a component provided in a moving body (AF carrier, zoom carrier, OIS carrier, etc.), in the embodiment of the present disclosure, a relatively small-sized magnet may be used, which may reduce the weight of the moving body and thereby further improve the driving efficiency.

In addition, since a relatively small-sized magnet is used, the leaked magnetic field itself may be reduced, which also reduces magnetic interference between adjacent magnets.

In this respect, it is desirable that the cover 520A is configured so that the magnets installed on different moving bodies are provided to approach each other due to the rotation of the moving bodies.

As explained above, when the carrier 120 rotates in the first direction with the middle guide 130 as a relative stator, the first magnet M1 also rotates, so the relative positional relationship between the first magnet M1 and the second magnet M2 dynamically changes.

Therefore, it is preferable that the first cover 520A of the first back yoke 500A and the second cover 520B of the second back yoke 500B described above are provided at a side where the first magnet M1 and the second magnet M2 approach each other by the first direction rotation.

In other words, the first cover 520A of the first back yoke 500A and the second cover 520B of the second back yoke 500B described above are provided in a direction along which the first magnet M1 and the second magnet M2 approach each other by the first direction rotation.

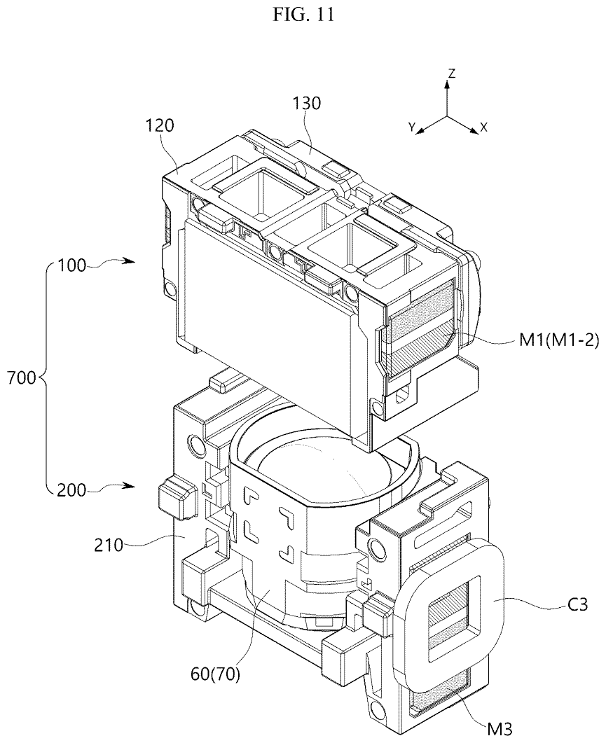

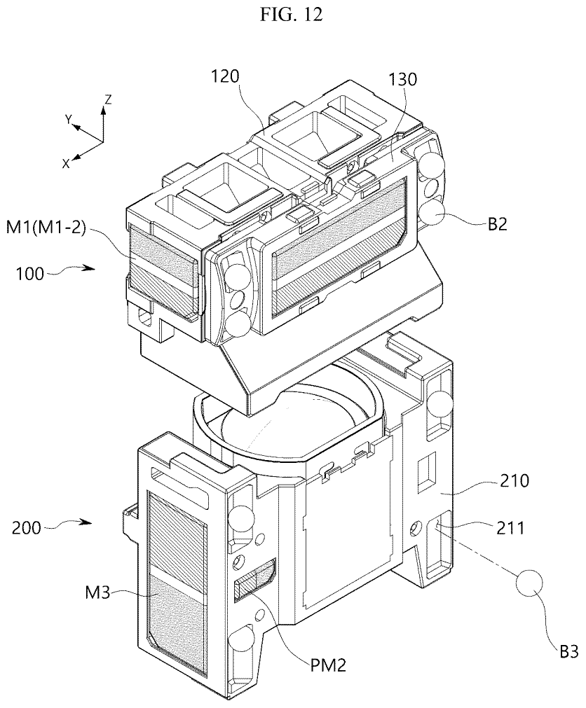

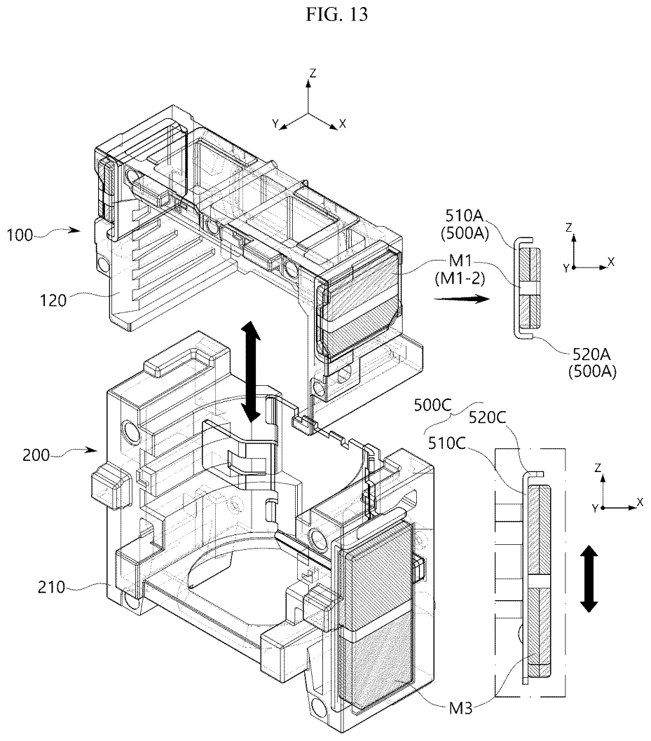

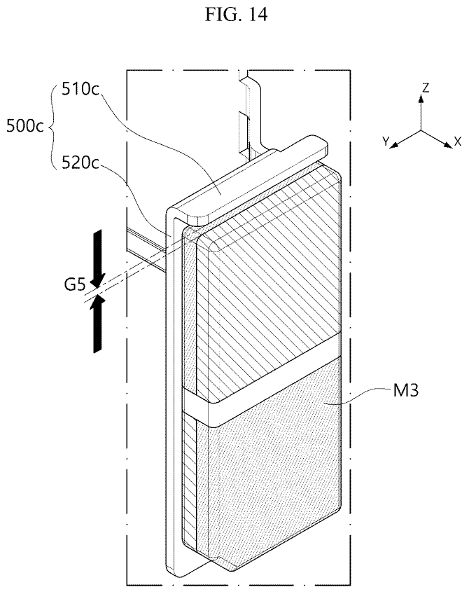

FIGS. 11 and 12 are drawings for illustrating a third carrier 210 moving in the optical axis direction, and FIGS. 13 and 14 are drawings for illustrating the structure of a third back yoke 500C installed on the third carrier 210 and its relationship with adjacent components.

The actuator 700 according to the embodiment illustrated in FIG. 11 may be implemented to further include a lens driving module 200 that moves in the optical axis as described above.

The lens driving module 200 may include a third carrier 210 that moves linearly in the optical axis direction (Z-axis direction) and at least one lens 60, 70 mounted on the second carrier 210.

A third magnet M3 facing the third coil C3 provided in the housing 140, etc. is installed on the third carrier 210 that moves in the optical axis direction. As described above, it is preferable that the third magnet M3 is installed on the third carrier 210 with the third back yoke 500C interposed therein to increase magnetic force and reduce leakage magnetic force.

Preferably, a third ball B3 may be arranged between the third carrier 210 and the housing 140. If the third ball B3 is interposed, the third carrier 210, which is a moving body, may move more flexibly and linearly with the housing 140 as a relative stator due to minimized friction caused by the rolling, moving, rotation, point-contact of the ball with respect to a facing object, and this may have the advantages of reduced noise, minimized driving force, and improved driving precision.

The third ball B3 may be arranged such that a portion of the third ball B3 is accommodated in a rail (not shown) formed on a surface of the housing 140 that faces the third carrier 210, or/and the third rail 211 formed on the third carrier 120, so as to effectively guide the linear movement of the third carrier 210.

Also, the third carrier 210 may be equipped with a yoke plate (not shown) provided in the housing 140 and made of magnetic material and a second pulling magnet PM2 that generates an attractive force.

In the relationship with the magnetic force, the second pulling magnet PM2 may also be installed in the stator housing 140, and a magnet or magnetic material member that generates an attractive force may also be installed on the third carrier 210.

If an attractive force is generated between the yoke plate and the second pulling magnet PM2 as above, the third carrier 210 comes into contact with the housing 140 with the third ball B3 interposed therebetween, so that point contact between the third ball B3 and the third carrier 210 as well as between the third ball B3 and the housing 140 may be continuously maintained.

When a current of an appropriate magnitude and direction is supplied to the third coil C3 by an external control signal or an internal algorithm, an electromagnetic force (magnetic force) is generated between the third coil C3 and the third magnet M3, and the third carrier 210 on which the third magnet M3 is installed moves in the optical axis direction by the generated electromagnetic force.

Like the first back yoke 500A and second back yoke 500B, a third back yoke 500C may be installed at the rear side of the third magnet M3 (between the third carrier 210 and the third magnet M3) to enhance the magnetic force of the third magnet M3 and prevent magnetic force leakage.

It is preferable that, like the first back yoke 500A or/and the second back yoke 500B described above, the third back yoke 500C is configured to cover the side surface of the third magnet M3 and includes a third cover 520C forming a gap G5 with the side surface of the third magnet M3. Reference sign 510C in FIGS. 13 and 14 corresponds to the body plate of the third back yoke 500C.

If the third carrier 210 moves upward along the optical axis direction, the third magnet M3 provided on the third carrier 210 approaches the first magnet M1 or the second magnet M2 located at the upper side (based on the Z-axis direction) of the third carrier 210, so magnetic interference may occur between them (between the first magnet M1 and the third magnet M3 or between the second magnet M2 and the third magnet M3).

Therefore, it is preferable that the third cover 520C is s provided at a side where the third magnet M3 approaching the first or second magnet M1, M2 by the optical axis direction movement of the third carrier 210. Based on the embodiment illustrated in the drawings, it is preferable that the third cover 520C is provided at the upper side (based on the optical axis) of the third magnet M3.

From a corresponding viewpoint, it is preferable that the first cover 520A or the second cover 520B of the first back yoke 500A is provided at a side where the third magnet M3 approaches the first or second magnet M1, M2 by the movement in the optical axis direction of the third carrier 210.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a camera, comprising:
a plurality of moving bodies configured for rotating in different directions;
a magnet installed on each of the plurality of moving bodies; and
a back yoke provided at a rear side of at least one of the magnets respectively installed on the plurality of moving bodies, the back yoke comprising a cover that forms a gap with a side surface of a magnet provided at a front side thereof and covers the side surface.

2. The actuator for a camera according to claim 1,
wherein the cover is provided at a side where magnets installed on different moving bodies approach each other by a rotation of the moving body.

3. An actuator for a camera, comprising:
a carrier having a reflector installed thereon and configured for rotating in a first direction;
a middle guide configured for rotating in a second direction perpendicular to the first direction;
a first magnet installed on the carrier;
a second magnet installed on the middle guide; and
a back yoke provided at a rear side of at least one of the first and second magnets, the back yoke comprising a cover that forms a gap with a side surface of a magnet provided at a front side thereof and covers the side surface.

4. The actuator for a camera according to claim 3, further comprising:
a housing configured to support the second direction rotation of the middle guide,
wherein the middle guide supports the first direction rotation of the carrier and rotates together with the carrier during the second direction rotation.

5. The actuator for a camera according to claim 3,
wherein the back yoke includes:
a first back yoke provided between the carrier and the first magnet; and
a second back yoke provided between the middle guide and the second magnet,
wherein at least one of the first back yoke or the second back yoke includes the cover.

6. The actuator for a camera according to claim 3,
wherein the cover is provided at a side where the first and second magnets approach each other by the first direction rotation.
